(19) United States
(12) Patent Application Publication
(10) Pub. No.: US 2007/0037799 A1
(43) Pub. Date: Feb. 15, 2007

(54) Fungicide ternary active ingredient combinations

(75) Inventors: Peter Dahmen, Neuss (DE); Asrtid Mauler-Machnik, Leichlingen (DE); Anne Suty-Heinze, Langenfeld (DE); Friedrich Kerz-Mohlendick, Leverkusen (DE)

Correspondence Address: STERNE, KESSLER, GOLDSTEIN & FOX PLLC, 1100 NEW YORK AVENUE, N.W., WASHINGTON, DC, 20005, US

(73) Assignee: Bayer Cropscience Aktiengesellschaft, Monheim (DE)

(21) Appl. No.: 10/565,883

(22) PCT Filed: Jul. 19, 2004
(86) PCT No.: PCT/EP04/08040

§ 371 Date: May 24, 2006

(30) Foreign Application Priority Data
Jul. 30, 2003 (DE) 103 35 183.3

(51) Int. Cl. A01N 43/64

(52) U.S. Cl. 514/229.2; 514/383

(57) ABSTRACT

The present invention relates to a novel active compound combination which consists of the known 3-{1-[2-(4-<2-chlorophenoxy>-5-fluoropyrimid-6-yloxy)phenyl]-1-(methoximino)methyl}-5,6-dihydro-1,4,2-dioxazine (fluoxastrobin) and of other known active compounds and is highly suitable for controlling phytopathogenic fungi.

The present invention relates to a novel active compound combination which consists of the known 3-{1-[2-(4-<2-chlorophenoxy>-5-fluoropyrimid-6-yloxy)phenyl]-1-(methoximino)methyl}-5,6-dihydro-1,4,2-dioxazine (fluoxastrobin) and of other known active compounds and is highly suitable for controlling phytopathogenic fungi.

It is already known that 3-{1-[2-(4-<2-chlorophenoxy>-5-fluoropyrimid-6-yloxy)phenyl]-1-(methoximino)methyl}-5,6-dihydro-1,4,2-dioxazine (fluoxastrobin) has fungicidal properties (cf. EP-A-0 882 043). The activity of this compound is good; however, at low application rates it is sometimes unsatisfactory.

Furthermore, it is already known that numerous azole derivatives can be used for controlling fungi (cf. Pesticide Manual, 11th Edition (1997), page 1144; WO 96/16048). However, at low application rates, the activity of these compounds is likewise not always satisfactory.

It has now been found that the novel active compound combination comprising

3-[1-[2-(4-<2-chlorophenoxy>-5-fluoropyrimid-6-yloxy)phenyl]-1-(methoximino)methyl]-5,6-dihydro-1,4,2-dioxazine (reference: DE-A-196 02 095) of the formula (I) 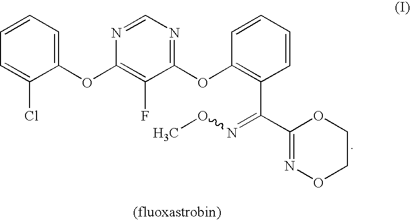
and
(1) the compound of the formula (II) (reference: WO 96/16048) 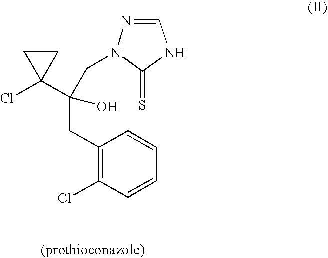
and
(2) the compound of the formula (III) (reference: EP-A-O-040 345) 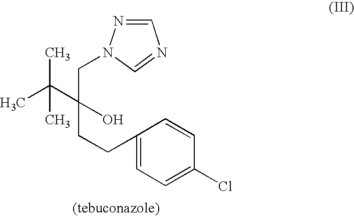
has very good fungicidal properties.

Surprisingly, the fungicidal activity of the active compound combination according to the invention comprising the three active compounds is considerably higher than the sum of the activities of the individual active compounds or the activity of the prior-art mixtures comprising in each case two active compounds. Thus, an unforeseeable true synergistic effect is present, and not just an addition of activities.

The active compound of the formula (I) is known (cf., for example, EP-A-0 882 043). The active compounds of the formulae (II) and (III) present in the active compound combination according to the invention in addition to the active compound of the formula (I) are likewise known (cf. references).

The following active compound combinations are also known:

Active compound combination comprising compounds of the formulae (I) and (II): WO 98/47367.

Active compound combination comprising compounds of the formulae (II) and (III): WO 98/47367.

If the active compounds in the active compound combination according to the invention are present in certain weight ratios, the synergistic effect is particularly pronounced. However, the weight ratios of the active compounds in the active compound combination can be varied within a relatively wide range.

In general,

0.1-10 parts by weight, preferably 0.2-5 parts by weight, of active compound of the formula (II), and

0.05-10 parts by weight, preferably 0.1-5 parts by weight, of active compound of the formula (III)

are present per part by weight of active compound of the formula (I).

The active compound combination according to the invention has very good fungicidal properties and can be employed for controlling phytopathogenic fungi, such as Plasmodiophoromycetes, Oomycetes, Chytridiomycetes, Zygomycetes, Ascomycetes, Basidiomycetes, Deuteromycetes, etc.

The active compound combination according to the invention is particularly suitable for controlling cereal diseases, such as Erysiphe, Cochliobolus, Pyrenophora, Rhynchosporium, Septoria, Fusarium, Pseudocercosporella and Leptosphaeria, Puccinia, Ustilago, Tilletia and Urocystis and for controlling fungal infections in non-cereal crops such as vine, fruit, groundnut, vegetables, for example Phythophthora, Plasmopara, Pythium, powdery mildew of fungi, such as, for example, Sphaerotheca or Uncinula, and causative organisms of leaf spot, such as Venturia, Alternaria and Septoria and also Rhizoctonia, Botrytis, Sclerotinia and Sclerotium.

The fact that the active compound combination is well tolerated by plants at the concentrations required for controlling plant diseases permits the treatment of above-ground parts of plants, of propagation stock and seeds, and of the soil. The active compound combination according to the invention can also be employed for foliar application or else as seed dressings.

The active compound combination according to the invention is also suitable for increasing the harvest yield. Moreover, it has reduced toxicity and is tolerated well by plants.

According to the invention, it is possible to treat all plants and parts of plants. Plants are to be understood here as meaning all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant cultivars which can or cannot be protected by plant breeders' certificates. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. Parts of plants also include harvested plants and vegetative and generative propagation material, for example seedlings, tubers, rhizomes, cuttings and seeds.

The treatment of the plants and parts of plants according to the invention with the active compounds is carried out directly or by activity on their environment, habitat or storage area according to customary treatment methods, for example by dipping, spraying, evaporating, atomizing, broadcasting, brushing-on and, in the case of propagation material, in particular in the case of seeds, furthermore by one- or multi-layer coating.

The active compound combination according to the invention can be converted to the customary formulations, such as solutions, emulsions, suspensions, powders, foams, pastes, granules, aerosols and microencapsulations in polymeric substances and in coating compositions for seeds, and ULV formulations.

These formulations are produced in a known manner, for example by mixing the active compounds or active compound combinations with extenders, that is liquid solvents, liquefied gases under pressure, and/or solid carriers, optionally with the use of surfactants, that is emulsifiers and/or dispersants, and/or foam formers. If the extender used is water, it is also possible to use, for example, organic solvents as auxiliary solvents. Essentially, suitable liquid solvents include: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclohexanone, strongly polar solvents such as dimethylformamide and dimethyl sulfoxide, or else water. Liquefied gaseous extenders or carriers are to be understood as meaning liquids which are gaseous at ambient temperature and under atmospheric pressure, for example aerosol propellants such as butane, propane, nitrogen and carbon dioxide. Suitable solid carriers are: for example ground natural minerals such as kaolins, clays, talc, chalk, quartz, attapulgite, montmorillonite or diatomaceous earth, and ground synthetic minerals such as finely divided silica, alumina and silicates. Suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates, or else protein hydrolyzates. Suitable dispersants are: for example lignin-sulfite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other additives can be mineral and vegetable oils.

It is possible to use colorants such as inorganic pigments, for example iron oxide, titanium oxide and Prussian Blue, and organic dyestuffs such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1 and 95% by weight of active compounds, preferably between 0.5 and 90%.

The active compound combination according to the invention, as such or in its formulations, can also be applied in a mixture with known fungicides, bactericides, acaricides, nematicides or insecticides, to broaden the activity spectrum or to prevent the development of resistance, for example.

A mixture with other known active compounds such as herbicides or with fertilizers and growth regulators is also possible.

The active compound combination can be used as such, in the form of its formulations or as the use forms prepared therefrom, such as ready-to-use solutions, emulsifiable concentrates, emulsions, suspensions, wettable powders, soluble powders and granules. They are used in the customary manner, for example by watering, spraying, atomizing, scattering, spreading, and as a powder for dry seed treatment, a solution for seed treatment, a water-soluble powder for seed treatment, a water-soluble powder for slurry treatment, or by encrusting.

When using the active compound combination according to the invention, the application rates can be varied within a relatively wide range, depending on the kind of application. In the treatment of parts of plants, the application rates of active compound combination are generally between 0.1 and 10 000 g/ha, preferably between 10 and 1000 g/ha. In the treatment of seeds, the application rates of active compound combination are generally between 0.001 and 50 g per kilogram of seed, preferably between 0.01 and 10 g per kilogram of seed. In the treatment of the soil, the application rates of active compound combination are generally between 0.1 and 10 000 g/ha, preferably between 1 and 5000 g/ha.

The good fungicidal activity of the active compound combination according to the invention is evident from the examples below. While the individual active compounds exhibit weaknesses with regard to fungicidal activity, the combinations made up of three active compounds have an activity which exceeds the sum of individual activities.

A synergistic effect in fungicides is always present when the fungicidal activity of the active compound combination is greater than the sum of the activities of the active compounds applied individually.

The expected activity for a given combination of 2 or 3 active compounds can be calculated in accordance with S. R. Colby (“Calculating Synergistic and Antagonistic Responses of Herbicide Combinations”, Weeds 1967, 15, 20-22) as follows:

If

X denotes the efficacy when using active compound A at an application rate of m g/ha,
Y denotes the efficacy when using active compound B at an application rate of n g/ha,
Z denotes the efficacy when using active compound C at an application rate of r g/ha,
E₁ denotes the efficacy when using active compounds A and B at application rates of m and n g/ha, and
E₂ denotes the efficacy when using active compounds A and B and C at application rates of m and n and r g/ha,
then

$${E}_{1} = X + Y - \frac{X \cdot Y}{100}$$

and for a combination of 3 active compounds:

$${E}_{2} = X + Y + Z - \frac{X \cdot Y - X \cdot Z - Y \cdot Z}{100} + \frac{X \cdot Y \cdot Z}{10000}$$

The efficacy here is determined in %. 0% denotes an efficacy which corresponds to that of the control, while an efficacy of 100% means that no infection is observed.

If the actual fungicidal activity is greater than that calculated, then the activity of the combination is superadditive: in other words, a synergistic effect is obtained. In this case the efficacy actually observed must be greater than the value calculated using the above-indicated formula for the expected efficacies E₁ and E₂, respectively.

The invention is illustrated by the example below. The invention is not, however, limited to the example.

### EXAMPLE

Erysiphe test (wheat)/curative

| | |
|---|---|
| Solvent: | 50 parts by weight of N,N-dimethylacetamide |
| Emulsifier: | 1 part by weight of alkylaryl polyglycol ether |

To produce a suitable preparation of active compound, 1 part by weight of active compound or active compound combination is mixed with the stated amounts of solvent and emulsifier, and the concentrate is diluted with water to the desired concentration.

To test for curative activity, young plants are dusted with spores of Erysiphe graminis f. sp. Tritici. 48 hours after the inoculation, the plants are sprayed with the preparation of active compound at the stated application rate.

The plants are placed in a greenhouse at a temperature of about 20° C. and a relative atmospheric humidity of about 80% to promote the development of mildew pustules.

Evaluation is carried out 8 days after the inoculation. 0% means an efficacy which corresponds to that of the control, whereas an efficacy of 100% means that no infection is observed.

TABLE
Erysiphe test (wheat)/curative

| | |
|---|---|
| Active compound | |
| application rate | Efficacy in % |

| Active compounds | in g/ha | found * | calc.** |
|---|---|---|---|
| (I) fluoxastrobin | 50 | 11 | |
| (II) prothioconazole | 50 | 0 | |
| (III) tebucinazole | 50 | 22 | |
| (I) + (II) 1:1 | 50 + 50 | 44 | 11 |
| (I) + (III) 1:1 | 50 + 50 | 67 | 31 |
| (II) + (III) 1:1 | 50 + 50 | 89 | 22 |
| (I) + (II) + (III) 1:1:1 | 50 + 50 + 50 | 100 | 31 |

* found = activity found
**calc. = activity calculated using Colby's formula

1. A composition, comprising a compound of the formula (I) 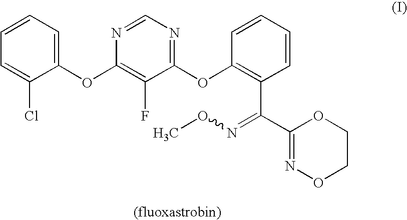
a compound of the formula (II) 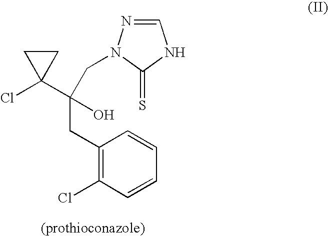
and
a compound of the formula (III)

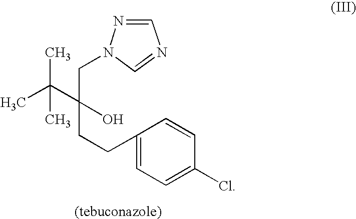

2. The composition of claim 1, characterized in that in the active compound combination the weight ratio of active compound of the formula (I)
to active compound of the formula (II) is from 1:0.1 to 1:10 and
to active compound of the formula (III) is from 1:0.05 to 1:10.

3. A method for controlling fungi, comprising allowing the composition of claim 1 to act on the fungi, their habitat or the plants, parts of plants, seeds, soils, areas, materials or spaces to be kept free from them.

4. The method for controlling fungi, characterized in that the compound of formula (I) 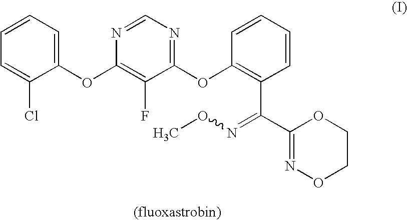
the compound of formula (II) 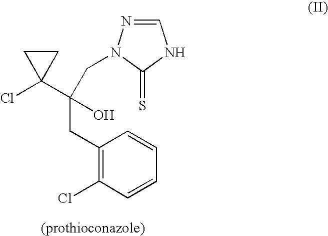
and the compound of formula (III) 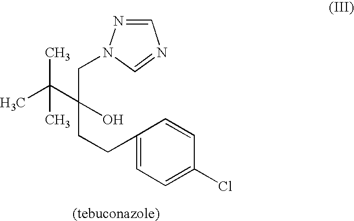
are applied simultaneously, that is jointly or separately, or in succession.

5. A propagation material which has been treated by the method of claim 3.

6-7. (canceled)

8. A process for preparing fungicidal compositions, characterized in that the active compound combination of claim 1 is mixed with extenders and/or surfactants.
